(19) United States
(12) Patent Application Publication
(10) Pub. No.: US 2003/0214189 A1
(43) Pub. Date: Nov. 20, 2003

(54) Advanced security notice keyless remote

(76) Inventors: Matthew Gerald Lupica, Macedonia, OH (US); Randy Norman Miller, Northfield, OH (US)

Correspondence Address: MATTHEW G. LUPICA, 9488 NORTH BEDFORD ROAD, MACEDONIA, OH, 44056, US

(21) Appl. No.: 10/150,869

(22) Filed: May 20, 2002

(51) Int. Cl. B60L 1/00

(52) U.S. Cl. 307/10.1

(57) ABSTRACT

You've just purchased a new vehicle and perhaps the car alarm goes off while you're at the movies, in a restaurant, or at a shopping mall. What purpose do all of the security features on your current keyless remote serve if there is no way of notifying you instantly that a situation has arisen? Now introducing the Advanced Security Notice Keyless Remote, a remote that gives you peace of mind by signaling the consumer via key beep or vibrate that your car has been tampered with, so you can take the necessary measures at that time.

### CROSS-REFERENCE TO RELATED APPLICATIONS

Not Applicable.

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM LISTING COMPACT DISC APPENDIX

Not Applicable.

### BACKGROUND OF THE INVENTION

This invention pertains to the field of the automobile industry, more specifically, the keyless remote systems which are currently on the market today. Current keyless remotes feature the open, unlock, panic and trunk release, but what it fails to feature is an option that allows the consumer to know whether or not the car is in danger while they are away.

### BRIEF SUMMARY OF THE INVENTION

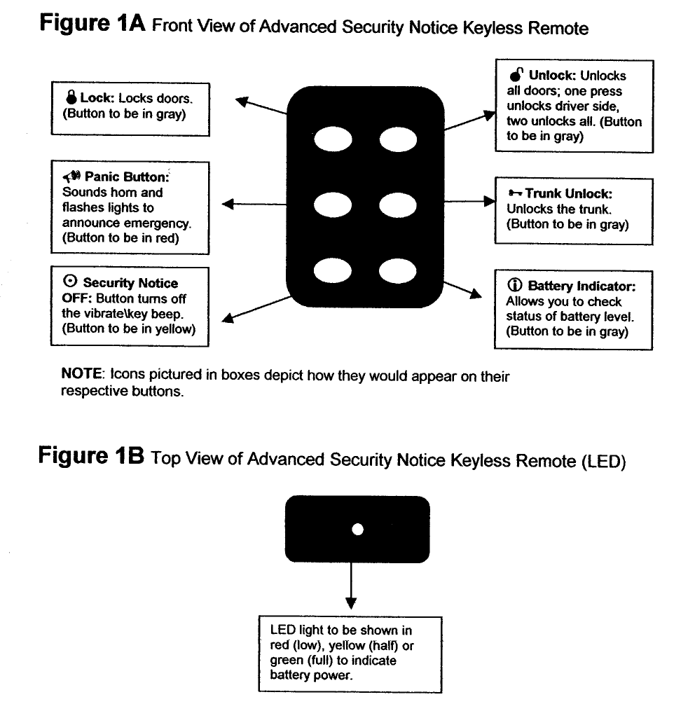

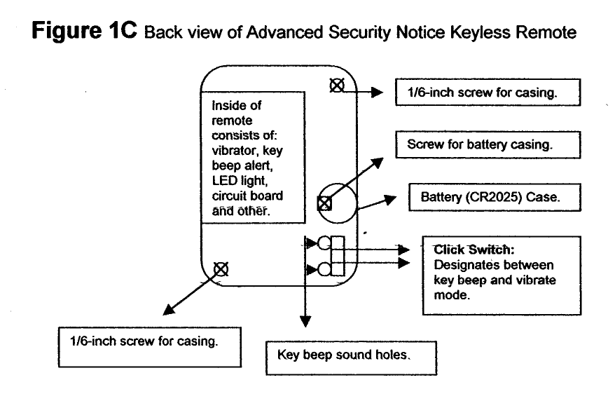

This invention will solve the problem as stated in section 0002 by combining the modern-day pager with a keyless remote. As every pager has a PIN (Personal Identification Number) or SCW (Security Code Word), every Advanced Security Notice Keyless Remote and vehicle would be assigned matching PINS. The remote, acting as a small receiver, would respond with a key beep or vibration, depending upon the setting selected (See FIG. 1C). As soon as a car door is a jarred or a window broken, thus activating the alarm, a terminal would simultaneously contact the satellite uplink. The satellite would then broadcast to a radio transmitter, messaging it as a radio signal. In other words, the signal would relay off the antenna transmitter and\or satellite and reach the keyless remotes. All of the remotes within the coverage, as served by the transmitter, would pick up the signal, but only the one with the matching PIN to the vehicle would be activated. The remote then signals the consumer with a key beep or vibration.

### BRIEF DESCRIPTION OF THE SEVERAL VIEWS OF THE DRAWING

In FIG. 1A, the front of the keyless-remote is shown, clearly depicting how the remote would be laid out and what each button's purpose is. In FIG. 1B, a picture of the top of the Advanced Security Notice Keyless Remote is shown with the LED light/battery indicator and what each color means. FIG. 1C shows the back view of the remote, and how it would be laid out.

### DETAILED DESCRIPTION OF THE INVENTION

The Advanced Security Notice Keyless Remote is a remote that centers around the modern day pager, and lets you know first hand of any unwanted dangers or intruders your car faces, no matter where you might be, all in the convenience of a device that fits in your pocket. On the Advanced Security Notice Keyless Remote, you can still expect to find the standard conveniences that are seen on current keyless remotes: lock, unlock, panic, and trunk unlock. However, what separates the Advanced Security Notice Keyless Remote from current remotes is that a vibrator and key beep, as seen in a pager, would be installed within the remote, which, in turn, would let the consumer know when the alarm system on the car goes off. A switch on the back of the remote allows you to choose between either key beep or vibrate mode (when remote is in pocket or if you're in a place where a key beep would be inappropriate). In the event that the alarm goes off, pressing the yellow Security Notice OFF button will end the vibrate\key beep. (See FIG. 1A) In addition, to assure your Advanced Security Notice Keyless Remote is in constant working order, the battery indicator button and LED light located on top of the remote keeps you up-to-date on battery power (See FIG. 1B). The composition of matter would consist of a plastic casing. Also, the remote would be made up of the same electronic components as there are in normal keyless remotes and pagers of today.

1. We claim as our invention the Advanced Security Notice Keyless Remote, a device that will revolutionize the automobile industry by taking the standard features of lock, un-lock, panic, and trunk unlock on today's remote and adding features such as the security notice button which turns off the alert, and an LED light which doubles as a battery checker that allows you to know instantly when your car is in danger, thus, ensuring optimum safety wherever you are.
